(19) United States
(12) Patent Application Publication
(10) Pub. No.: US 2018/0150880 A1
(43) Pub. Date: May 31, 2018

(54) TARGETED DIGITAL CONTENT DELIVERY FOR VEHICLES

(71) Applicant: Microsoft Technology Licensing, LLC, Redmond, WA (US)

(72) Inventors: Stephen O'Driscoll, Bray (IE); David Mowatt, Dublin (IE)

(21) Appl. No.: 15/363,211

(22) Filed: Nov. 29, 2016

(51) Int. Cl. G06Q 30/02; G01C 21/34

(52) U.S. Cl. CPC G06Q 30/0266; G06Q 30/0242; G06Q 50/30; G01C 21/3484; G06Q 30/0269

(57) ABSTRACT

A system and method for delivering targeted digital content within a vehicle. The system includes a database storing demographic data associated with historical riders of the vehicle and a server communicatively coupled to the database. The server includes an electronic processor. The electronic processor is configured to determine a current location of the vehicle. The electronic processor is configured to determine an average rider profile based on the current location of the vehicle and the demographic data associated with historical riders of the vehicle stored in the database. The electronic processor is configured to determine, based on the average rider profile, the targeted digital content. The electronic processor is configured to transmit the targeted digital content to an electronic presentation device located within the vehicle.

### FIELD

Embodiments described herein relate to targeting digital content delivery, and, more particularly, to targeting the delivery of digital content on electronic presentation devices in vehicles, retail locations, and other places where one or more individuals may be present.

### SUMMARY

Vehicles, such as buses, trains, subways, taxis, elevators, and other vehicles carry a large number of passengers, including students, commuters, tourists, festival goers, and the like. Traditionally, these vehicles include printed material, such as on billboards, that provide data on public service announcements, events, attractions, promotions, and the like. Similar printed material may be used in retail locations, such as stores, restaurants, movie theaters, sporting event venues, and other locations were goods or services are offered to consumers. For example, printed posters or labels may be positioned within a retail location to provide data on promotions, new products, suggested product pairings or usage, and the like. In both situations, however, the printed material is often ignored by consumers as consumers are more likely to view digital content on their portable electronic devices, such as smartphones, smart watches, and the like.

Furthermore, the printed material is static and, hence, may quickly become out-of-date. For example, when printed material in a bus is promoting an upcoming festival, the printed material immediately becomes out-of-date when the festival ends and often cannot be quickly changed at that point in time. To overcome these and other issues, the printed material may be replaced with an electronic presentation device that displays digital content that may be quickly updated as needed to keep the displayed data relevant. However, the number and demographics (background, culture, interest, economic status, and the like) of the consumers viewing such digital content may vary over time. Thus, although displayed digital content may be relevant to one consumer at one point it time, it may not be relevant to another consumer at the same point in time, or to future consumers.

For example, a commuter heading to work may not be interested in digital content related to a daytime sporting event. Similarly, a tourist heading to an entertainment district may not be interested in the nearest grocery store and a student visiting a grocery store may not be interested in baby items or high-end or luxury items. Thus, even when printed material is replaced with digital content, time and resources are wasted presenting digital content to groups of consumers. Furthermore, it may be difficult or impossible to identify each consumer who may view digital content and specifically tailor displayed digital content to each individual consumer, especially when consumers may view digital content concurrently for non-overlapping periods of time.

Thus, embodiments described herein provide, among other things, systems and methods for delivering targeted digital content within vehicles, retail locations, and other places where numerous individuals may be present. For example, the system and method described herein may provide targeted digital content within a vehicle based on rider-related data, such as intended destination, rider characteristics including demographic, social, and occupation data, and the like, and vehicle-related data, such as geo-location, direction, route, and the like. Rider-related data may be collected through vehicle-related software applications (for example, software application for purchasing, locating, or using rides a vehicle) or in exchange for services available on the vehicle, such as network connectivity. For example, a rider may provide demographic data in exchange for accessing Wi-Fi or other networks available on the vehicle. From this rider-data, demographics regarding average riders may be identified, which may be supplemented with demographics regarding current riders and general demographic data, such as average salaries or house prices within a particular geographical location. Thus, this rider-related data as well as vehicle-related data is collected, processed, correlated, and communicated to provide digital content targeted based on actual, current riders of the vehicle, an average rider of the vehicle, route data, time of day data, event data, weather data, geo-location data, and the like. This functionality may be used in any type of vehicle including self-driving cars and taxis as well as mass transit vehicles, including buses, trains, subways, airplanes, and the like and allows digital content to be targeted to riders even when exact data regarding current riders is not available or is incomplete.

Similarly, the system and method may provide targeted digital content within a retail location based on an analysis of current consumers within the retail location, an average consumer within the retail location, merchandise (goods or services) available at the retail location, and consumer's intended action and behavior, such as what merchandise a consumer has already purchased or placed in their cart or bag (generically referred to as a container in the present application), what merchandise is close to the consumer, and the like. Thus, this consumer-related data as well as merchandise data is collected, processed, correlated, and communicated to provide digital content targeted to an actual, consumer present at the retail location, an consumer present at the retail location, or a combination thereof based time of day data, event data, weather data, and the like.

One embodiment provides a system for delivering targeted digital content within a vehicle. The system includes a database storing demographic data associated with historical riders of the vehicle and a server communicatively coupled to the database. The server includes an electronic processor. The electronic processor is configured to determine a current location of the vehicle. The electronic processor is configured to determine an average rider profile based on the current location of the vehicle and the demographic data associated with historical riders of the vehicle stored in the database. The electronic processor is configured to determine, based on the average rider profile, the targeted digital content. The electronic processor is configured to transmit the targeted digital content to an electronic presentation device located within the vehicle.

Another embodiment provides a method for delivering targeted digital content within a vehicle. The method includes accessing demographic data for a plurality of historical riders of the vehicle accessing demographic data associated with a current location of the vehicle. The method also includes determining, with an electronic processor, based on the demographic data for the plurality of historical riders and the demographic data associated with the current location of the vehicle, an average rider profile. The method also includes determining, with the electronic processor, based on the average rider profile, the targeted digital content. The method also includes transmitting, with the electronic processor, the targeted digital content to an electronic presentation device located within the vehicle.

Another embodiment provides a non-transitory computer-readable medium. The medium includes instructions executable by an electronic processor to perform a set of functions. The set of functions includes determining at least one current rider of a vehicle. The set of functions also includes determining at least one current rider profile based on the at least one current rider of the vehicle. The set of functions also includes determining a current location of the vehicle. The set of functions also includes determining an average rider profile based on the current location of the vehicle. The set of functions also includes determining targeted digital content based on the average rider profile and the at least one current rider profile. The set of functions also includes transmitting the targeted digital content to the mobile communication device.

### BRIEF DESCRIPTION OF THE DRAWINGS

FIG. 1 schematically illustrates a system for delivering targeted digital content within a vehicle according to some embodiments.

FIG. 2 is a block diagram of a server included in the system of FIG. 1 according to some embodiments.

FIG. 3 is a flowchart of a method of delivering targeted digital within a vehicle using the system of FIG. 1 according to some embodiments.

FIG. 4 schematically illustrates a system for delivering targeted digital content within a retail location according to some embodiments.

FIG. 5 is a flowchart of a method of delivering targeted digital content delivery within a retail location using the system of FIG. 4 according to some embodiments.

### DETAILED DESCRIPTION

Before any embodiments are explained in detail, it is to be understood that the embodiments described herein are not limited in their application to the details of construction and the arrangement of components set forth in the following description or illustrated in the following drawings. Embodiments may be practiced or carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “connected” and “coupled” are used broadly and encompass both direct and indirect mounting, connecting, and coupling. Further, “connected” and “coupled” are not restricted to physical or mechanical connections or couplings, and may include electrical connections or couplings, whether direct or indirect. Also, electronic communications and notifications may be performed using any known means including direct or indirect wired connections, wireless connections, and combinations thereof. Also functionality described as being performed by one device may be distributed among a plurality of devices.

It should also be noted that a plurality of hardware and software based devices, as well as a plurality of different structural components may be used to implement the embodiments set forth herein. In addition, it should be understood that embodiments may include hardware, software, and electronic components that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments may be implemented in software (e.g., stored on non-transitory computer-readable medium) executable by one or more electronic processors.

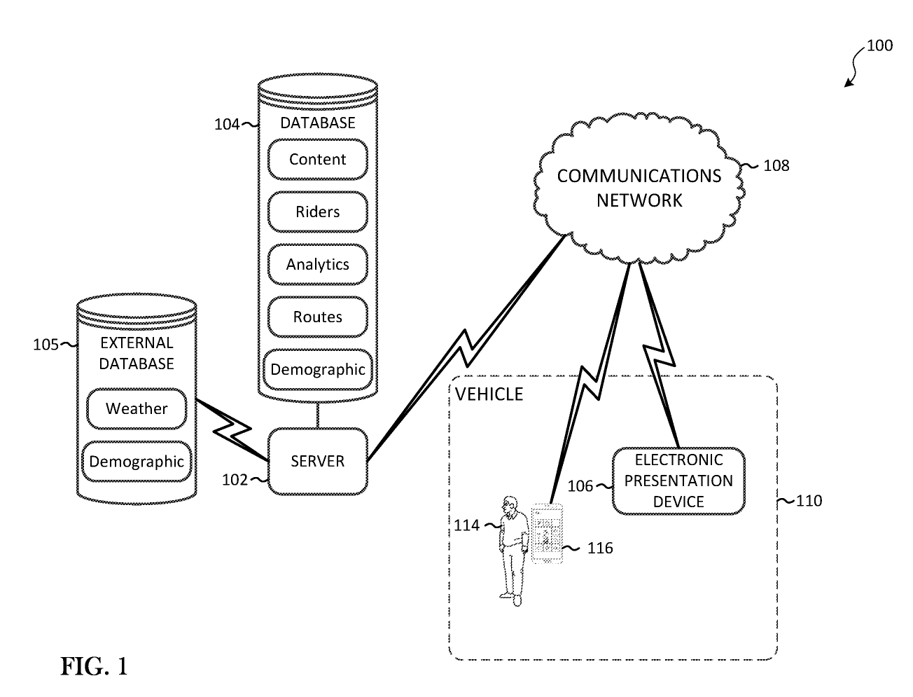

FIG. 1 schematically illustrates a system 100 for delivering targeted digital content. As illustrated in FIG. 1, the system 100 includes a remote computer or server 102, a database 104, an external database 105, and an electronic presentation device 106. The server 102 and the electronic presentation device 106 are communicatively coupled via a communications network 108. The communications network 108 may be implemented using a wide area network, such as the Internet, a local area network, such as a Bluetooth™ network or Wi-Fi, a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3GSM network, a 4GSM network, and combinations or derivatives thereof. It should be understood that the system 100 is provided as an example and, in some embodiments, the system 100 may include additional components. For example, the system 100 may include multiple servers 102, multiple databases 104, multiple external databases 105, multiple electronic presentation devices 106, or a combination thereof.

As described in more detail below, the server 102 uses data stored in the database 104 and the external database 105 to determine targeted digital content. As used herein, the term “digital content” refers to digital media, such as text, images, video, audio, and combinations of the foregoing. After determining the targeted digital content, the server 102 transmits the targeted digital content to the electronic presentation device 106, which outputs (displays) the targeted digital content. As illustrated in FIG. 1, the electronic presentation device 106 is located within a vehicle 110. The vehicle 110 may be, for example, a bus, a subway, a train, a taxi, an airplane, a ferry, an elevator, an escalator, a tram, a moving walkway, or similar mode of transportation for one or more individuals. As illustrated in FIG. 1, in some embodiments, a current rider 114 of the vehicle 110 may carry a mobile communication device 116, such as a smart phone, a tablet computer, a smart watch or other wearable, or the like. As described in detail below, the mobile communication device 116 may transmit data to the server 102, may serve as another electronic presentation device 106, or a combination thereof. Similarly, the server 102 and the databases 104, 105 may reside on the same physical machine or in the same data center.

As illustrated in FIG. 1, the database 104 may be a database housed on a suitable database server communicatively coupled to and accessible by the server 102. In alternative embodiments, the database 104 may be part of a cloud-based database system external to the system 100 and accessible by the server 102 over one or more additional networks. In some embodiments, all or part of the database 104 may be locally stored on the server 102.

In some embodiments, as illustrated in FIG. 1, the database 104 electronically stores digital content, rider data, analytics data, route data, and demographic data. It should be understood that, in some embodiments, the data stored in the database 104 is distributed among multiple databases that communicate with the server 102 and, optionally, each database may store specific data used by the server 102 as described herein. For example, in some embodiments, the database 104 is distributed as content database, a riders database, an analytics database, a routes database, a demographic database, or a combination thereof, which may be included in a common database server or separate database servers, included in the server 102, or a combination thereof.

In some embodiments, the server 102 accesses data (for example, demographic data and weather data) from the external database 105. The external database 105 may be a public or private database, such as a data store or data service accessible by the server 102 over one or more additional networks. In some embodiments, the server 102 may access the database 104, the external database 105, or both, via the communications network 108.

The stored digital content may include videos, images, sounds, or a combination thereof. The stored digital content may be tagged with data such as a source of the digital content, subject matter of the digital content, a price associated with the digital content, and the like. In some embodiments, stored digital content may also be associated with preferred targets, such as particular riders of the vehicle 110, particular routes, particular destinations, particular time of day or dates, and the like.

The rider data includes demographic data for riders of the vehicle 110. Riders may include registered riders, current riders, historical riders, prospective riders, or a combination thereof. Prospective riders may include individuals that have acquired (for example, purchased) rides for the vehicle 110 or other data regarding the vehicle 110 (for example, route data from a website associated with the vehicle) but may have not actually ridden the vehicle 110 yet. The demographic data may include occupation, salary, gender, family data, hobbies, and the like. In some embodiments, the demographic data for the riders is collected from, for example, a payment or tracking system used by riders of the vehicle 110. For example, registered riders of the vehicle 110 may use website or a software application (for example, executed by a mobile communication device) to track vehicle availability, time tables, and prices, book rides or reservations, purchase prepaid rides, and the like. As part of using these services associated with the vehicle 110, the rider may be prompted or required to enter demographic data. Alternatively or in addition, the vehicle 110 may condition network accessibility within the vehicle 110 on the submission of rider demographic data. For example, to use the vehicle's Wi-Fi service, a rider may need to provide demographic data. In some embodiments, this demographic data may also be aggregated from other systems unrelated to vehicle 110, such as collected from social media systems or loyalty systems associated with other vehicles or other goods or services, or from applications installed on a rider's mobile electronic device. In some embodiments, the demographic data may include, for example, housing prices, social housing data, restaurant prices, or other generally available demographic data (for example, as available from the external database 105).

The analytics data includes data capturing the activities of historical riders of the vehicle 110, such as what riders have gone on what routes, at what times, on what days, and to what destinations. Again, this data may be collected through a website or a software application (for example, executed by a mobile communication device) associated with the vehicle 110, geo-location of riders or the vehicle, or ticket or payment systems that track when a rider boards the vehicle 110 and when the rider exits the vehicle 110 to calculate fees. For example, a rider may use his or her mobile communication device to present a boarding pass or other electronic ticket to board the vehicle 110 and may similarly represent the same or a different pass or ticket to exit the vehicle 110. Thus, this data may be tracked to identify what riders use what routes, on what days, at what times, and to what destinations. Again, this data may also be aggregated from other sources, including social media systems or credit card or other ticket sale information used to purchase tickets at a machine.

The route data includes predefined or historical routes for a vehicle 110, including a starting location, an ending location, and any stops along the way, as well as time tables for such routes (for example, vehicle 110 arrives at the corner of Main Street and 1^{st} Street at 8:10 a.m. Monday through Friday). The route data may also include current location data for the vehicle 110 along a particular route as well as what direction the vehicle 110 is traveling (for example, east-bound on route 40 or west-bound on route 40). In some embodiments, the route data also includes data regarding riders (for example, specific riders, the number of riders, or a combination thereof) that board the vehicle 110 or exit the vehicle at particular stops along a route or at particular destinations. The route data may also include current travel data, such as current time and day, current weather at various locations, and the like.

The demographic data includes demographic data for particular areas that may be unrelated to riders. For example, the demographic data may include average house prices in an area, number of schools in an area, a designation of urban or rural areas, income levels in an area, occupations in an area, purchasing history in an area, consumer spending habits in an area, cultural interests in an area, education level in an area, and the like. In some embodiments, the demographic data may be collected from a variety of public and private databases (for example, the external database 105).

As noted above, the server 102 uses the data stored in the database 104 to determine targeted content for current riders of the vehicle 110. The targeted content is transmitted to the electronic presentation device 106, which outputs the targeted content. The electronic presentation device 106 includes components (for example, a microprocessor, a network interface, a display, and a speaker) that enable the device 106 to receive, process, and output digital content. For example, the electronic presentation device 106 may be a monitor, a tablet computer, a smart TV, or a similar electronic device. The electronic presentation device 106 is positioned within a vehicle 110 and mounted on various surfaces of the vehicle 110 such that riders present on the vehicle 110 experience the content by seeing the content, hearing the content, or a combination thereof. In some embodiments, multiple electronic presentation devices 106 may be located in multiple portions of the vehicle, and may present different content, depending on the riders located in the portions of the vehicle. In some embodiments, as described in more detail below, the mobile communication device 116 carried by the current rider 114 of the vehicle 110 may also operate as an electronic presentation device 106 to display targeted digital content.

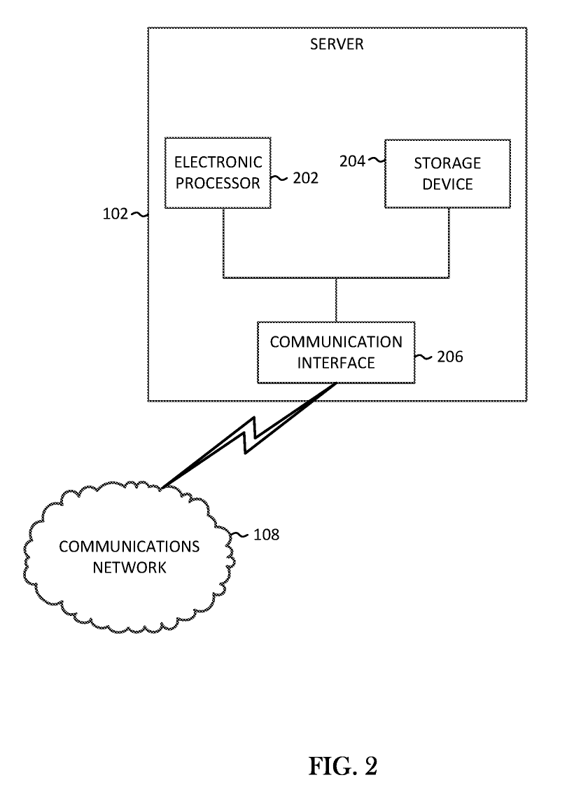

FIG. 2 schematically illustrates the server 102 in more detail. As illustrated in FIG. 2, the server 102 includes an electronic processor 202 (for example, a microprocessor, application-specific integrated circuit (ASIC), or another suitable electronic device), a storage device 204 (for example, a non-transitory, computer-readable storage medium), and a communication interface 206, such as a transceiver, for communicating over the communications network 108 and, optionally, one or more additional communication networks or connections. It should be understood that the server 102 may include additional components than those illustrated in FIG. 2 in various configurations and may perform additional functionality than the functionality described in the present application. Also, it should be understood that the functionality described herein as being performed by the server 102 may be distributed among multiple devices, such as multiple servers and may be provided through a cloud computing environment, accessible by components off the system 100 via the communications network 108.

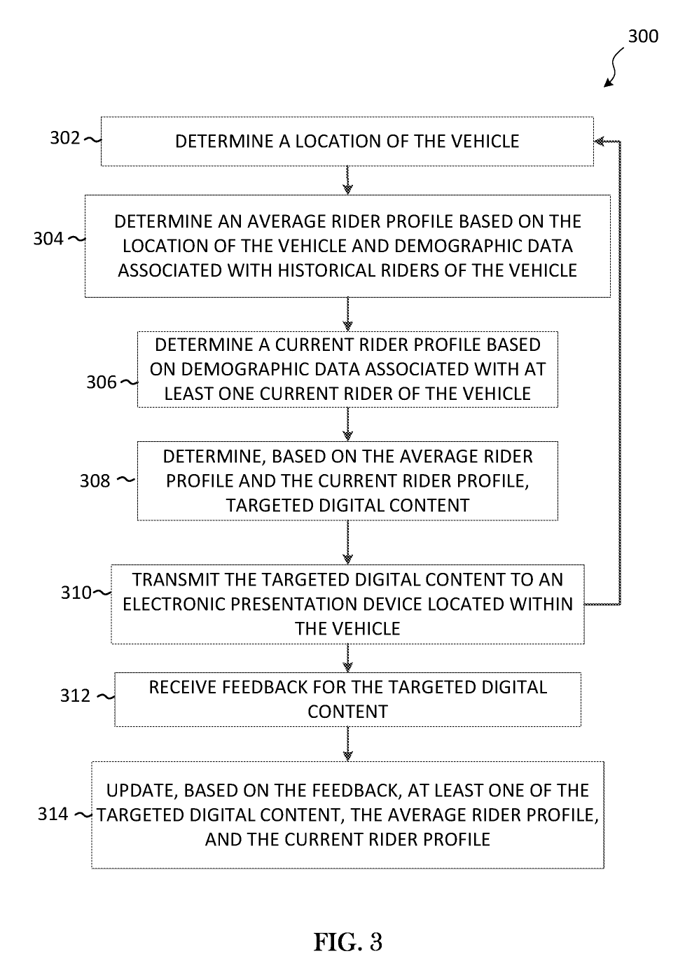

The electronic processor 202, the storage device 204, and the communication interface 206 included in the server 102 communicate over one or more communication lines or buses. The electronic processor 202 is configured to retrieve from the storage device 204 and execute, among other things, software related to the control processes and methods described herein. For example, FIG. 3 illustrates a method 300 for delivering targeted digital content within the vehicle 110 performed by the server 102 according to one embodiment. The method 300 is described as being performed by the server 102 and, in particular, the electronic processor 202. However, it should be understood that in some embodiments, portions of the method 300 may be performed by other devices, including for example, the mobile communication device 116 carried by the current rider 114.

As illustrated in FIG. 3, at block 302, the electronic processor 202 determines a current location of the vehicle 110. As described above, the current location of the vehicle 110 may be stored in the database 104 and may be obtained from a geo-location system. In other embodiments, the electronic processor 202 may determine the current location of the vehicle 110 based on the current time of day and the currently scheduled route of the vehicle 110. In one example, at noon on Mondays, the electronic processor 202 may identify that the vehicle 110 is at a first stop along its route.

Based on the current location of the vehicle, the electronic processor 202 determines an average rider profile (at block 304). The average rider profile may define demographic data for an average rider of the vehicle 110 at the location. As described above, the database 104 stores rider data, analytics data, and route data, which the electronic processor 202 may access to determine an average rider profile. For example, the electronic processor 202 may identify, based on stored demographic data for historical riders of the vehicle 110, that the average rider on the vehicle 110 at the location is 83.2% likely to be a female commuter who makes approximately $50,000 to $80,000 per year, is 60% likely to be married, likes cycling, and is 74% likely to live in rented property in a northern suburb of the downtown area (for example, based on what demographics are associated with the greatest percentage of historical riders). In some embodiments, general demographic data not associated with historical riders may also be used to supplement one or more portions of the average rider profile. In some embodiments, that database 104 stores such average rider profiles for particular locations (for example, as defined by a vehicle predetermined or historical stops or destinations, which may be updated periodically), and the electronic processor 202 accesses the predefined average rider profiles. In other embodiments, the electronic processor 202 generates such a profile based on current data stored in the database 104. Accordingly, the electronic processor 202 may determine an average ride profile for a vehicle 110 by accessing demographic data for a plurality of historical riders of the vehicle 110, and, optionally, general demographic data for an area associated with the vehicle 110 stored in the database 104.

Also, it should be understood that average rider profiles may be defined for a vehicle 110 or a particular route service by the vehicle 110 and may not be limited to a particular location of a vehicle, such as a destination or a stop of the vehicle 110. Also, in some embodiments, in addition to or as an alternative to defining an average rider profile for a particular location, the average rider profiles may be defined for a particular time of day, a particular day, a particular time of year, weather conditions, or other factors that impact the demographic make-up of a rider of the vehicle 110. For example, the average rider may change depending on whether it is rush hour or an off-peak time, based on whether it is a weekday, a weekend day, or a holiday, and the like. Also, in some embodiments, the database 104 may contain data on events happening near the current time of day or in the areas serviced by the vehicle 110. For example, when a large sporting event is occurring soon and close by to the vehicle 110, the average rider profile may include sports fans.

Optionally, in some embodiments, the electronic processor 202 also determines a current rider profile based on demographic data associated with at least one current rider of the vehicle 110 (at block 306). The current rider profile may define demographic data for one or more current riders of the vehicle 110. As described above, the database 104 stores rider data, analytics data, and route data, which the electronic processor 202 may use to determine a current rider profile for a single or multiple current riders or to determine multiple current rider profiles, such as one for each current rider. For example, the electronic processor 202 may access current rider identifiers stored in the database 104 and may use these identifiers to access associated demographic data (if any) for the identified current riders. When determining a current rider profile for multiple current riders, the electronic processor 202 may determine average demographics for the group of current riders, such as what demographics have the highest percentage among the current riders similar to how the electronic processor 202 determines the average rider profile. Accordingly, based on the demographic data for the identified current riders, the electronic processor 202 may identify that a current rider on the vehicle 110 is a male commuter who makes approximately $100,000 annually as an accountant, is single, and owns a house in a northern suburb of the downtown area. In some embodiments, general demographic data may also be used to supplement one or more portions of the current rider profile. For example, when the available demographic data for a current rider does not indicate an occupation for the rider, the electronic processor 202 may supplement the current rider profile with an occupation based on demographic data. Again, as noted above for the average rider profiles, in some embodiments, the database 104 stores rider profiles (updated periodically) and the electronic processor 202 accesses predefined rider profiles based on the current riders. In other embodiments, the electronic processor 202 generates such a profile based on current data stored in the database 104.

Based on the average rider profile and, optionally, any available current rider profiles, the electronic processor 202 determines targeted digital content (at block 308). As described above, the database 104 stores potential digital content. Thus, the electronic processor 202 may identify, from the potential digital content, the targeted content based on the average rider profile and, optionally, any available current rider profiles. When both an average rider profile and one or more current rider profiles are available, the electronic processor 202 may combine the profiles. For example, the electronic processor 202 may supplement missing or incomplete data in a current rider profile with data from the average rider profile or vice versa. Furthermore, in some embodiments, the electronic processor 202 may compare data of an average rider profile with the data of a current rider profile and override data in the average rider profile with the data in the current rider profile (or vice versa) when the data diverges. Accordingly, as described herein, the electronic processor 202 may determine the targeted digital content based on the average ride profile and any available current rider profiles as a group or a single consolidated profile. In some embodiments, the electronic processor 202 may rank or weigh registered current rider profiles based on a comparison of the quantity of registered current riders to total riders (for example, by using sensors to estimate a total passenger count). In one example, the electronic processor 202 may weigh the current rider profiles more heavily than average rider profiles when the number of riders registered and detected in the system exceeds 50% of the total current riders.

In some embodiments, the electronic processor 202 may determine the targeted digital content by filtering the potential digital content based on the profiles (for example, when tourists are using the vehicle 110 the electronic processor 202 may filter out digital content tagged as being directed to a commuter or a professional). Alternatively or in addition, the electronic processor 202 may determine the targeted digital content by assigning one or more scores to potential digital content using statistical modeling or other techniques. For example, the electronic processor 202 may, for each aspect of a profile, assign a score to potential digital content. In particular, when a profile includes a certain probabilistic indication of a rider having a family, the electronic processor 202 may assign each potential digital content a score that indicates how relevant the digital content is to this particular demographic. This score may be based on the tags provided for the digital content as described above, such as preferred audience for digital content. The electronic processor 202 then adds up all of the weighted scores for the potential digital content and compares scores of potential digital content to select the targeted digital content, such as by selecting the potential digital content with the highest score. Alternatively or in addition, potential digital content may be associated with a predefined score or ranking that defines how well potential digital content appeals to particular predefined demographics (for example, women, high income, low income, families, students, hot weather, and the like). In some embodiments, the scores or rankings may range from 0.0 to 1.0, where a score or ranking of 1.0 indicates that the digital content appeals to a particular demographic and a score of 0.0 indicates that the digital content does not appeal to a particular demographic. These scores or ranks may also be used as weights as described below.

In some embodiments, potential digital content may include (for example, be associated with) with one or more weights (also stored in the database 104) that may control the selection of targeted digital content. For example, filtered potential digital content or scored digital content as described above may be further processed or sorted based on assigned weights, and individual weights may be set based on content prices, last selection, historical relevance or effectiveness, and the like. In another example, for some digital content, certain rider characteristics (for example, salary) may be considered more important than other characteristics (for example, homeowner versus renter), and thus would be assigned a greater weight. In particular, the score determined for particular potential digital content as described above may be multiplied by an assigned weight associated with the content that results in a final score that is ranked to identify the targeted digital content. Thus, the weights may be used to override or influence digital content selection. For example, to keep targeted digital content fresh, the weight associated with digital content may be increased or decreased when the content is selected or not selected as the targeted digital content or may be increased or decreased randomly to again keep content fresh while also potentially boosting newly submitted content or preventing digital content from never being shown. As described in more detail below, this weight may also be modified based on feedback received for digital content.

In some embodiments, the electronic processor 202 also determines the targeted content based on additional data separate from the profiles. For example, the electronic processor 202 may determine a weather condition based on the location of the vehicle 110, and may determine the targeted digital content based on the profiles and the weather condition. For example, when it is raining, a rider of the vehicle 110 may be less likely to walk a long distance from a stop, and, thus, digital content related to destinations a long distance from an upcoming stop may be less relevant than digital content related to closer destinations. In some embodiments, the weather condition is taken into account after digital content is filtered or scored, as described above, or through the use of a weight, as described above. However, alternatively or in addition, an average rider profile may be defined for a particular weather condition.

In some embodiments, the electronic processor 202 also determines the targeted content based on data on current riders determined using facial recognition. For example, a camera may be positioned in the vehicle 110 to capture images of riders as they board the vehicle 110. Such images may be analyzed using facial recognition technology to determine characteristics of the riders (for example, gender, age, clothing style, and the like), which characteristics may be used to determine the targeted digital content. For example, some targeted digital content may be more relevant to women than men. In some embodiments, the characteristics are taken into account after digital content is filtered or scored, as described above, or through the use of a weight, as described above.

Regardless of how the electronic processor 202 determines the targeted digital content, the electronic processor 202 transmits the targeted digital content (via the communications network 108) to an electronic presentation device 106 located within the vehicle 110 (at block 310). The electronic presentation device 106 outputs the targeted digital content, which may include displaying the content on a display device, such as monitor, playing the content through a speaker, or a combination thereof. As noted above, in some embodiments, the mobile communication device 116 of a current rider 114 of the vehicle 110 acts as the electronic presentation device 106 and outputs the targeted digital content to the current rider 114. For example, the mobile communication device 116 may be using a Wi-Fi service, which is briefly interrupted to present the targeted digital content. In some embodiments, whether the electronic processor 202 considers whether the targeted digital content is being transmitted to the electronic presentation device 106, the mobile communication device, or both to select the targeted digital content. For example, when the targeted digital content is transmitted to the mobile communication device 116, the electronic processor 202 may select digital content that closely matches a current rider profile rather than the average rider profile. As illustrated in FIG. 3, in some embodiments, the electronic processor 202 refreshes the targeted digital content periodically to update the targeted digital content based on updated digital content, updated average rider profiles, updated demographic data, updated current riders, and the like.

As illustrated in FIG. 3, the electronic processor 202 may receive feedback associated with the targeted digital content (at block 312). For example, when the targeted digital content is output through the mobile communication device 116, the feedback may indicate whether or not the rider “clicked through” the digital content to obtain additional data, skipped at least a portion of the digital content, visited a website associated with the digital content, or performed other activities by the current rider 114 through the mobile communication device 116 or other devices associated with the current rider 114 implying that the rider responded positively or negatively. For example, in some embodiments, the rider may be only required to watch a portion (five seconds) of the digital content and may skip (close) a remaining portion of the digital content (a remaining twenty-five seconds). Thus, whether a rider views the digital content in its entirety or skips at least a portion of the digital content may provide feedback regarding whether digital content was positively or negatively received.

Similarly, when the targeted digital content is output through the electronic presentation device 106, the feedback may include scanning a quick response (QR) or other machine-readable code included in the digital content or visiting a website associated with the digital content. Also, in some embodiments, the electronic processor 202 determines a plurality of options for the targeted digital content and presents the options to the rider where the rider is prompted to or required to select one of the options. Accordingly, the option selected by the rider provides feedback that the rider considers the selected option more relevant than the other options. Feedback may also be received through surveys, coupon usage, actual sales increases or decreases associated with the digital content, keyword search trends, or other mechanisms (for example, by using image capture devices to track a visitor's eye movements or gaze).

Based on this feedback, the electronic processor 202 may update the digital content, an average rider profile, a current rider profile, or a combination thereof (at block 314). For example, in some embodiments, the electronic processor 202 updates a score or a weight associated with the targeted digital content as described above based on the feedback. For example, positive feedback may be used to increase the score or weight and negative feedback may be used to decrease the score or weight. Similarly, when the feedback is negative, the electronic processor 202 may update a demographic defined in the average rider profile or a current rider profile, such as by setting the defined demographic to the next demographic with the highest percentage among the historical riders. For example, when a rider provides negative feedback for targeted content (directly or indirectly) this feedback may indicate that the average rider profile or the current rider profile is flawed and should be modified accordingly. Thus, based on the feedback, the server 102 may adaptively learn more accurate profiles and, hence, better select relevant targeted digital content.

Accordingly, the functionality described above, allows the server 102 to delivery targeted digital content based on historical riders of the vehicle 110 as well as current riders and general demographic data. By combining these pieces of data, the system 100 does not need to track every current rider of the vehicle 110 but still aims to provide relevant digital content for current riders based on historical and general demographic data.

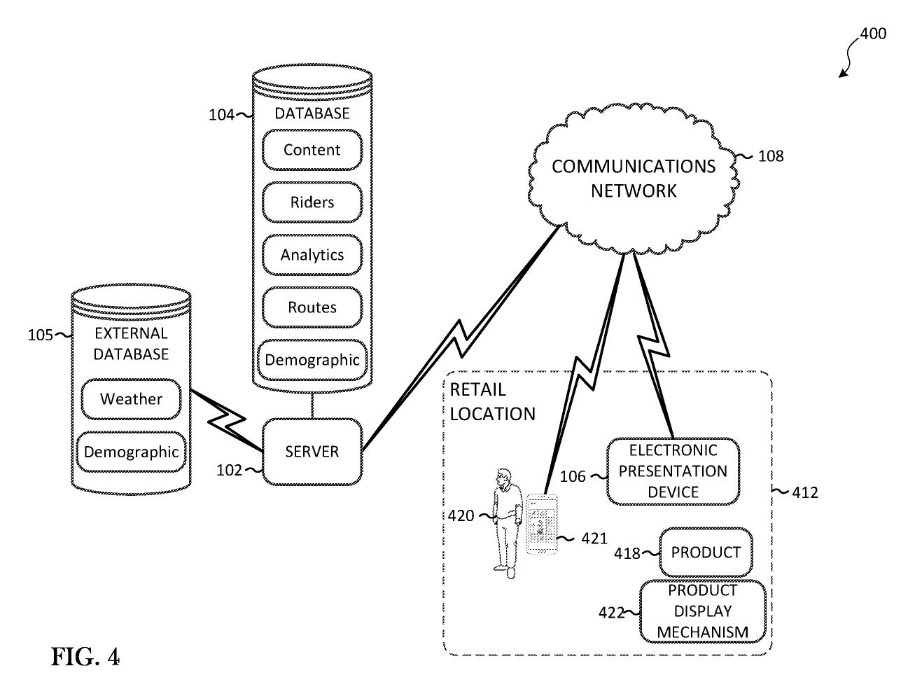

The functionality described above with respect to the vehicle 110 may also be used in the context of a retail location, such as a store, a restaurant, a theater, a sporting event venue, a gym, and other locations were goods or services are offered to consumers. For example, FIG. 4 illustrates a system 400 for delivering targeted digital content. As illustrated in FIG. 4, the system 400 includes the server 102, the database 104, and the electronic presentation device 106 as described above with respect to FIG. 1. Again, it should be understood that the system 400 is provided as an example and, in some embodiments, the system 400 may include additional components. For example, the system 400 may include multiple servers 102, multiple databases 104, multiple electronic presentation devices 106, or a combination thereof.

As described above, the server 102 uses data stored in the database 104 to determine targeted digital content and transmits the targeted digital content to the electronic presentation device 106, which outputs (displays) the targeted digital content. As illustrated in FIG. 4, the electronic presentation device 106 in this embodiment is located within a retail location 412, such as, for example, a grocery store, a clothing store, a home improvement store, and the like. As described in more detail below, the electronic presentation device 106 is may be positioned proximate to one or more products 418 being offered for sale or consumption within the retail location 412 and presents digital content relating to the product 418 to a current visitor 420 of the retail location 412. In some embodiments, the retail location 412 also includes a product display mechanism 422. The product display mechanism 422 may include one or more mechanical assemblies, such as servo motors or other devices, that move product 418 for prominent display within the retail location 412. For example, the product display mechanism 422 may include a rotatable or slidable shelf that supports different products 418 which may be moved (for example, rotated, slid, and the like) to position different products 418 at the front or in a prominent position of the product display mechanism 422. As described in more detail below, the product display mechanism 422 may include an interface for communicating with the server 102 that allows the server 102 to control the product display mechanism 422 to control what products 418 may be displayed or presented to a visitor of the retail location 412. For example, the server 102 may control the product display mechanism 422 to display a product 418 associated with targeted digital content currently displayed on the electronic presentation device 106. In some embodiments, similar to the vehicle embodiment described above, a mobile communication device 421 of the visitor 420 may also be used as an electronic presentation device 106 for displaying targeted digital content.

As illustrated in FIG. 4, in some embodiments, the database 104 electronically stores digital content, visitor data, analytics data, product data, device data, and demographic data. It should be understood that, in some embodiments, the data stored in the database 104 is distributed among multiple databases that communicate with the server 102 and, optionally, each database may store specific data used by the server 102 as described herein. For example, in some embodiments, the database 104 is distributed as a content database, a visitors database, an analytics database, a product database, a device database, a demographic database, or a combination thereof, which may be included in a common database server or separate database servers, included in the server 102, or a combination thereof.

As described above for the system 100, the stored digital content may include videos, images, sounds, or a combination thereof. The stored digital content may be tagged with data such as a source of the digital content, subject matter of the digital content (for example, a product), a price associated with the digital content, and the like. In some embodiments, stored digital content may also be associated with preferred targets, such as particular visitors to the retail location 412, particular time of day dates, and the like.

The visitor data includes demographic data on registered visitors to the retail location 412. The registered visitors may include current visitors, historical visitors, prospective visitors, or a combination thereof. Prospective visitors may include individuals that have purchased gift cards for the retail location 412, signed up for a mailing or distribution list for the retail location 412, visited a website associated with the retail location 412, signed up for a loyalty program associated with the retail location 412 or related relation locations, or reside or work within a particular distance from the retail location 412 but may have not actually visited the retail location 412 yet. In some embodiments, the database 104 may store demographic data on historical or prospective visitors and a separate dynamic visitors database may contains data on current visitors to the retail location 412. This data may include unique identifiers for current visitors that may be used to pull demographic data for the visitor, such as from a loyalty system. In some embodiments, the data included in the dynamic visitors database includes data on the current visitors current or potential purchases, such as what products 418 are included in the visitor's cart or bag (container). For example, a container used by the current visitor may have scanners to track product 418 placed within the container. Similarly, cameras may be used to visually identify what products 418 a visitor as placed within his or her container. Containers may also provide location data for a current visitor that indicates where within the retail location 412 the current visitor is currently or historically. Similarly, in some embodiments, a current visitor may have a software application associated with the retail location 412 installed on his or her mobile communication device 421, such as a loyalty program application, which may provide data regarding the current visitor's location, shopping list, purchases, and the like.

The demographic data stored for registered visitors may include occupation, salary, gender, family data, hobbies, and the like. In some embodiments, the demographic data for the registered visitors is collected from, for example, a payment or loyalty systems used by visitors to the retail location 412 where, as part of using these services, the visitor is prompted or required to enter demographic data. Alternatively or in addition, the retail location 412 may condition network accessibility within the retail location 412 on the submission of visitor demographic data. For example, to use a Wi-Fi service of the retail location 412, a visitor may need to provide demographic data. In some embodiments, this demographic data may also be aggregated from other systems unrelated to retail location 412, such as collected from social media systems or loyalty systems associated with other retail locations or other goods or services. For example, demographic data may be collected for visitors that “check in” at the retail location 412 within a social network system.

The analytics data includes data capturing the activities of historical visitors and historical products 418 of the retail location 412, such as what products 418 sold in the past, in what quantities, and to what segment of visitors, the quantity of product 418 purchased on a particular day or time or associated with a particular event (for example, Thanksgiving, the Super Bowl, and the like), demographical breakdowns of purchases between visitors with different economic statuses, purchases based on weather conditions, past purchases in the retail location 412, related retail locations, online sales, or a combination thereof. Again, this data may be collected through payment, loyalty, or inventory systems associated with the retail location 412 but may also be aggregated from other sources, including social media systems. In some embodiments, the analytics data also records what digital content led to purchases and associated revenue impacts of digital content within the retail location 412 or other retail locations. This data may alternatively or additionally be included in the content data.

The product data includes products offered for sale, rent, or consumption within the retail location 412. The product data may include a product identifier (for example, a bar code, a stock keeping unit (SKU), or the like), a name or description, a price, a profit margin, a manufacturer, and the like. In some embodiments, the product data may also include an ontology of products, such as categorizations or relationships between products to group similar or complimentary products together. The device data records locations of electronic presentation devices 106, such as with respect to a map of the retail location 412 (for example, an aisle, department, or the like), what products 418 are located proximate to an electronic presentation device 106, or a combination thereof. In some embodiments, radio-frequency identification (RFID) may be used to automatically detect products located around an electronic presentation device 106. In some embodiments, the device data also includes regarding what digital content was output on a particular electronic presentation device 106 at a particular time. This data may alternatively or additionally be included in the content data.

The demographic data includes demographic data for an area associated with the retail location 412 that may be specific to any registered visitors. For example, the demographic data may include average house prices in an area, number of schools in an area, a designation of urban or rural areas, income levels in an area, occupations in an area, purchasing history in an area, consumer spending habits in an area, cultural interests in an area, education level in an area, and the like. In some embodiments, the demographic data may be collected from a variety of public and private databases.

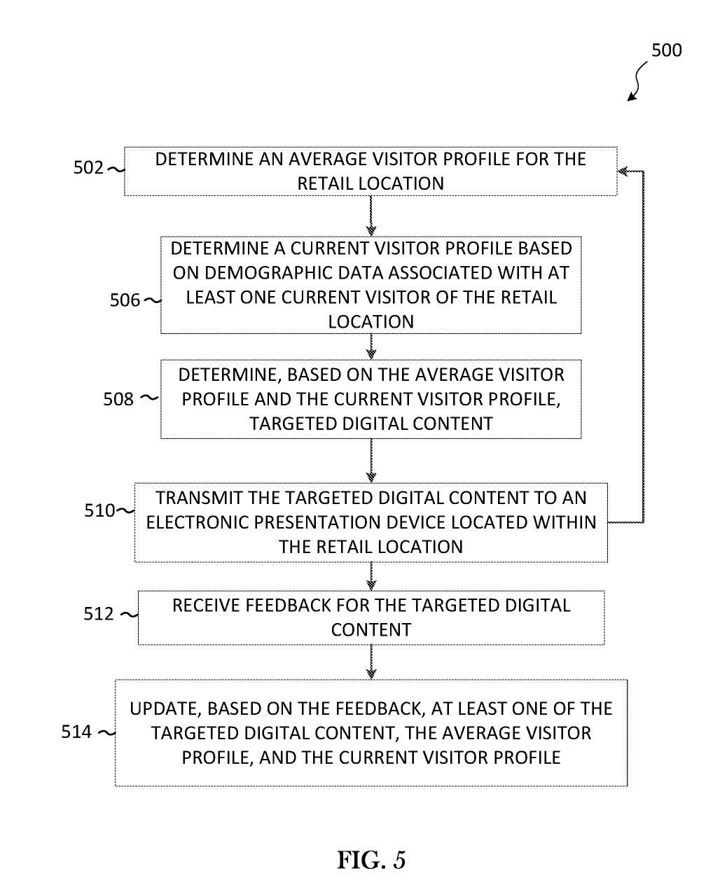

Based on the above-described data, the server 102 determines targeted digital content and transmits the targeted digital content to the electronic presentation device 106. For example, FIG. 5 illustrates a method 500 for delivering targeted digital content within the retail location 412 performed by the server 102 included in the system 400 according to one embodiment. The method 500 is described as being performed by the server 102 and, in particular, the electronic processor 202. However, it should be understood that in some embodiments, portions of the method 500 may be performed by other devices, including for example, the mobile communication device 421 carried by the current visitor 420.

As illustrated in FIG. 5, at block 502, the electronic processor 202 determines an average visitor profile for the retail location 412. As described above for the average rider profile, the average visitor profile may define demographic data for an average visitor of the retail location 412. As described above, the database 104 stores visitor data and analytics data, which the electronic processor 202 may access to determine an average visitor profile. For example, the electronic processor 202 may identify, based on stored demographic data for historical visitors of the vehicle 110, that the average visitor to the retail location 412 is 81.5% likely to be a female professional who makes approximately $50,000 to $80,000 per year, is 30% likely to be married, 56% likely to purchase organic vegetables, and is 70% likely to live in rented property in a northern suburb of the downtown area. It should be noted that at some times, some aspects of the profile may be indeterminate (for example, the average visitor may be just as likely as not to have children). In some embodiments, general demographic data not associated with historical visitors may also be used to supplement one or more portions of the average visitor profile. In some embodiments, that database 104 stores an average visitor profile (updated periodically) and the electronic processor 202 accesses the predefined average visitor profile. In other embodiments, the electronic processor 202 generates such a profile based on current data stored in the database 104. Accordingly, the electronic processor 202 may determine an average visitor profile for the retail location 412 by accessing demographic data for a plurality of historical visitors to the retail location 412, and, optionally, general demographic data for an area associated with the retail location 412 stored in the database 104.

Also, it should be understood that average visitor profiles may be defined for a particular time of day, a particular day, a particular time of year, weather conditions, a particular area of the retail location 412, a particular product 418, or other factors that impact the demographic make-up of a visitor of the retail location 412. For example, as noted above, the database 104 may store demographic data demographic data for historical visitors to the retail location 412 and people living in the area of the retail location 412. This may be used to generate an average visitor profile including, for example, spending power, education level, and best-selling products. As another example, the early evening hours may be more likely to see commuters returning from work, and the daytime hours may be more likely to see retired people or homemakers. As yet another example, very cold weather may indicate that the average visitor is more likely to purchase something because they braved the elements. In another example, the weather may be used to indicate a likelihood of intent to purchase seasonal products. Also, in some embodiments, the database 104 may contain data on events happening near the current time of day or in the areas associated with the retail location 412. For example, when a large sporting event is occurring soon and close by to the retail location 412, the average visitor profile may include sports fans or particular product purchases, such as snack food.

Optionally, in some embodiments, the electronic processor 202 also determines a current visitor profile based on demographic data associated with at least one current visitor to the retail location 412 (at block 506). The current visitor profile may define demographic data for one or more current visitors to the retail location 412. As described above, the database 104 stores visitor data, including, for example, a dynamic visitors database and analytics data, which the electronic processor 202 may use to determine a current visitor profile for a single or multiple current visitors or to determine multiple current visitor profiles, one for each current visitor. For example, the electronic processor 202 may access current visitor identifiers stored in the database 104 and may use these identifiers to access associated demographic data (if any) for the identified current visitors. Accordingly, based on the demographic data for the identified current visitors, the electronic processor 202 may identify that a current visitor of the retail location 412 as a male student who is single, and purchases frozen foods. In some embodiments, general demographic data not associated with visitors may also be used to supplement one or more portions of the current visitor profile. For example, when the available demographic data for a current visitor does not indicate an occupation for the visitor, the electronic processor 202 may supplement the current visitor profile with an occupation based on demographic data. Again, as noted above for the average rider profiles, in some embodiments, the database 104 stores visitor profiles (updated periodically) and the electronic processor 202 accesses predefined visitor profiles based on the current visitors. In other embodiments, the electronic processor 202 generates such a profile based on current data stored in the database 104.

Based on the average visitor profile and, optionally, any available current visitor profiles, the electronic processor 202 determines targeted digital content (at block 508). As described above, the database 104 stores potential digital content. Thus, the electronic processor 202 may identify, from the potential digital content, the targeted content based on the average visitor profile and, optionally, any available current visitor profiles. In some embodiments, when both an average visitor profile and one or more current visitor profiles are available, the electronic processor 202 may combine the profiles. For example, the electronic processor 202 may supplement missing or incomplete data in a current visitor profile with data from the average visitor profile or vice versa. Furthermore, in some embodiments, the electronic processor 202 may compare data of an average visitor profile with the data of a current visitor profile and override data in the average visitor profile with the data in the current visitor profile (or vice versa) when the data diverges. Accordingly, as described herein, the electronic processor 202 may determine the targeted digital content based on the average visitor profile and any available current visitor profiles as a group or a single consolidated profile. For example, for the system 400, the electronic processor 202 may determine a current visitor profile and, to compensate for not all visitors being accurately tracked or identified, supplement the current visitor profile with data from the average visitor profile, which, as described above, may be defined for a particular time of day, a particular day, a particular weather condition, historical visitors in with a predetermined past period of time, and the like. Thus, the resulting profile represents a weighted average of a visitor most likely to be present in the retail location and viewing the electronic presentation device 106. As described above, in some embodiments, the electronic processor 202 may weigh current visitor profile data over average visitor profile data, based on what percentage of the total current visitors in the retail location are identified current visitors.

As described above for the system 100, in some embodiments, the electronic processor 202 may determine the targeted digital content by filtering the potential digital content based on the profiles (for example, when students are visiting the retail location 412, the electronic processor 202 may filter out digital content tagged as being directed to high-priced or luxury products). Similarly, when determining targeted digital content for a particular electronic presentation device 106, the electronic processor 202 may identify what products 418 (for example, by product identifier) are positioned proximate to the device 106 and may filter out digital content that is not associated with such products, related products, or complimentary products (for example, as defined in the optional ontology of products). Alternatively or in addition, as also described above, the electronic processor 202 may determine the targeted digital content by assigning one or more scores to potential digital content using statistical modeling or other techniques and may use one or more weights to further rank potential digital content. Furthermore, in some embodiments, the electronic processor 202 also determines the targeted content based on additional data separate from the profiles. For example, the electronic processor 202 may determine a weather condition for the retail location 412 and may determine the targeted digital content based on the profiles and the weather condition. In some embodiments, the weather condition is taken into account after digital content is filtered or scored as defined above or through use of a weight as described above. However, alternatively or in addition, an average visitor profile may be defined for a particular weather condition.

In general, before or after filtering or scoring potential digital content based on the products 418 displayed proximate to an electronic presentation device 106, the electronic processor 202 may rank potential digital content based on one or more inputs and select the targeted digital content based on the rankings, such as what digital content is ranked first or last. The inputs (for example, accessed from the database 104) may include the historical digital content displayed on the electronic presentation device 106 and historical sales for the products 418, which may indicate the digital content's success in driving increased sales. In one example, visitors who saw an image of a father roasting a turkey in the past bought more products from a particular display shelf (displaying, for example, turkey, gravy, and basting trays) than visitors who saw an image of falling leaves. This ranking may be based on average visitor profiles, current visitor profiles, or both and may use actual products purchased, profit margin, or a combination thereof. Other inputs may take into account factors such as average profit margins across a group of products, driving product sales for other products, and reductions in product sales due to other product sales. Similarly, inventory data may be used to identify what products may have an increased inventory as compared to other products such that digital content for those products should be selected as the targeted digital content. After generating one or more rankings and combining ranking as applicable, the electronic processor 202 may select the targeted digital content by selecting a highly-ranked digital content that appears relevant based on the average visitor profile and any current visitor profiles.

As described above with respect to the system 100, in some embodiments, the electronic processor 202 also determines the targeted content using facial recognition. For example, a camera may be positioned in the retail location 412 to capture images of visitors as they enter the retail location 412. Such images may be analyzed using facial recognition technology to determine characteristics of the current visitors (for example, gender, age, clothing style, and the like), which characteristics may be used to determine the targeted digital content. For example, some targeted digital content may be more relevant to older visitors than younger visitors. In some embodiments, the characteristics are taken into account after digital content is filtered or scored, as described above, or through the use of a weight, as described above.

Regardless of how the electronic processor 202 determines the targeted digital content, the electronic processor 202 transmits the targeted digital content (via the communications network 108) to an electronic presentation device 106 located within the retail location 412 (at block 510). The electronic presentation device 106 outputs the targeted digital content, which may include displaying the content on a display device, such as monitor, playing the content through a speaker, or a combination thereof. As noted above, in some embodiments, the mobile communication device 421 of a current visitor 420 of the retail location 412 acts as the electronic presentation device 106 and outputs the targeted digital content to the current visitor 420. As illustrated in FIG. 5, in some embodiments, the electronic processor 202 refreshes the targeted digital content periodically to update the targeted digital content based on updated digital content, updated average visitor profiles, updated demographic data, updated product data, updated current visitors, and the like.

In some embodiments, as noted above with respect to FIG. 4, the retail location 412 includes a product display mechanism 422 that is configured to change the position of products 418, such as by rotating, sliding, or otherwise moving a display shelf. In these embodiments, the electronic processor 202 may transmit the targeted digital content and may also transmit signals to the product display mechanism 422 that requests a particular position of products to best complement the targeted digital content.

As illustrated in FIG. 5, the electronic processor 202 may receive feedback data associated with the targeted digital content (at block 512), which as described above, the electronic processor 202 may use to update the targeted digital content, the average visitor profile, current visitor profile, or other data stored in the database 104 (at block 514). For example, the electronic processor 202 track purchases made by current visitors present in the retail location 412 when the targeted digital content was output (for example, based on scanned product in the visitor's container, purchases made by the visitor, or a combination thereof) to identify whether any current visitors purchased products 418 associated with the targeted digital content. Similarly, the electronic processor 202 may track inventory levels and profit margins for products 418 associated with targeted digital content. In some embodiments, feedback indicating products as they are selected by a visitor (as compared to when they are purchased) may be given greater weight as there is a closer connection between the digital content and the product selection. As described above, this feedback may be stored to the database 104, such as part of the device data, the analytics data, and the like.

Thus, the functionality described above allows the server 102 to delivery targeted digital content based on historical visitors to a retail location 412 as well as current visitors and general demographic data, which eliminates the need to track every current visitor while still providing relevant content. It should also be understood that the functionality described above with respect to the systems 100 and 400 may be combined in various ways. For example, in some embodiments, the server 102 may access an average or current visitor profile of a retail location 412 located proximate to a vehicle 110 and may use the average visitor profile to supplement the average rider profile for the vehicle 110. In particular, the sever 102 may set the average rider profile to be similar to the average visitor or current visitors in the retail location 412 when the vehicle 110 is traveling toward the retail location 412, such as when the vehicle's next stop is close to the retail location 412. The server 102 may similarly use an average or current rider profile of the vehicle 110 to supplement the average visitor profile for the retail location 412. Similarly, in some embodiments, the targeted digital content transmitted to the electronic presentation device 106 located within the vehicle 110 may include digital content also transmitted to the electronic presentation device 106 located within the retail location 412 or vice versa.

Similarly, when a potential visitor is detected for the retail location 412 (for example, through a geo-fence (that is, the potential visitor is located within a predetermined distance from the retail location 412), or as a rider on an approaching vehicle 110) by the server 102, the server 102 may include demographic data for the potential visitor as part of the current or average visitor data for the retail location 412. Alternatively or in addition, when the demographics of the potential visitor match demographics associated with targeted digital content transmitted to the retail location 412, the server 102 may transmit targeted digital content to a mobile communication device of the potential visitor associated with the retail location 412 or a personalized notification or message. For example, the server 102 may transmit an email or a text alert to the mobile communication device of the potential visitor alerting the potential visitor that particular product 418 is available in the retail location 412. In some embodiments, the potential visitor is the current rider 114 of the vehicle 110.

In some embodiments, the digital content used in the above described systems 100 and 400 may be represented by templates that define a position, orientation, and the like for individual digital content. For example, a template may define areas of and positions for a display filled with images or videos, placeholders for fixed text, placeholders for variable text, and the like. Thus, the server 102 may determine targeted digital content by identifying a template (which may be a default template) and determining the data to populate the template. Also, in some embodiments, the server 102 may customize targeted digital content. For example, after determining the targeted digital content as described above, the server 102 may personalize the targeted digital content based on an average or current profile. In particular, the server 102 may vary text included in the targeted digital content or images or video included in the targeted digital content to make the targeted digital content even more relevant to riders or visitors. In addition, the server 102 may add branding data to digital content to personalize the content for a particular vehicle 110, retail location 412, or the like. Also, it should be understood that in some embodiments, the digital content includes smells or scents that may be generated to trigger a rider's or visitor's sense of smell. Also, it should be understood that the digital content may be interactive and allow a rider or visitor to navigate through different aspects of the digital content as desired. Such interaction, as described above, may be used as feedback for the digital content.

In some embodiments, the server 102 also provides an interface that creators or managers of digital content may use to submit or edit digital content, including tags. For example, a manufacturer or retailer may submit digital content through the interface or marketing agencies may submit digital content through the interface. Also, owners or operators of a vehicle or a retail location may access digital content through the interface to control weights, scores, or other parameters associated with digital content. Creators or managers of digital content may also use the interface to view performance data for digital content, including credit payments (for example, based on a per-impression payment or bonuses for high-performing content). The interface may also provide feedback regarding what digital content drove sales of particular products or services. Also, in some embodiments, the interface may allow a manager (such as an operator or manager of a vehicle or a retail location) to view selected targeted content and optionally approve such selected targeted content before the content is transmitted to an electronic presentation device 106 for output.

Thus, embodiments provide, among other things, systems and methods for targeted digital content delivery in a vehicle, in a retail location, or other locations where numerous individuals gather. As described above, the targeted digital content is determined based on average rider or visitor demographic data, which may be supplemented with available demographic data for current riders or visitors. Furthermore, feedback on the targeted digital may be used to improve future selection of targeted digital content. Various features and advantages of some embodiments are set forth in the following claims.

What is claimed is:

1. A system for delivering targeted digital content within a vehicle, the system comprising:
a database storing demographic data associated with historical riders of the vehicle;
a server communicatively coupled to the database and including an electronic processor configured to
determine a current location of the vehicle;
determine an average rider profile based on the current location of the vehicle and the demographic data associated with historical riders of the vehicle stored in the database;
determine, based on the average rider profile, the targeted digital content; and
transmit the targeted digital content to an electronic presentation device located within the vehicle.

2. The system of claim 1, wherein the electronic processor is further configured to determine at least one current rider profile for at least one current rider of the vehicle and is configured to determine the targeted digital content based on the average rider profile and the at least one current rider profile.

3. The system of claim 1, wherein the electronic presentation device is a mobile communication device of at least one current rider of the vehicle.

4. The system of claim 1, wherein the electronic processor is configured to determine the targeted digital content by
determining a first score for first potential digital content based on the average rider profile,
determining a second score for second potential digital content based on the average rider profile, and
selecting one of the first potential digital content and the second potential digital content as the targeted digital content by comparing the first score and the second score.

5. The system of claim 1, wherein the electronic processor is further configured to receive feedback for the targeted digital content, and update, based on the feedback, at least one selected from a group consisting of the digital content, the average user profile, and the current rider profile.

6. The system of claim 5, wherein the feedback includes an indication of whether a current rider of the vehicle skipped at least a portion of the targeted digital content.

7. The system of claim 1, wherein the electronic processor is configured to determine the average rider profile based on the current location of the vehicle and a time of day.

8. The system of claim 1, wherein the electronic processor is further configured to determine a weather condition based on the current location of the vehicle and is configured to determine the targeted digital content based on the average rider profile and the weather condition.

9. A method for delivering targeted digital content within a vehicle, the method comprising:
accessing demographic data for a plurality of historical riders of the vehicle;
accessing demographic data associated with a current location of the vehicle;
determining, with an electronic processor, based on the demographic data for the plurality of historical riders and the demographic data associated with the current location of the vehicle, an average rider profile;
determining, with the electronic processor, based on the average rider profile, the targeted digital content; and
transmitting, with the electronic processor, the targeted digital content to an electronic presentation device located within the vehicle.

10. The method of claim 9, further comprising determining at least one current rider profile for at least one current rider of the vehicle and wherein determining the targeted digital content includes determining the targeted digital content based on the average rider profile and the at least one current rider profile.

11. The method of claim 9, wherein transmitting the targeted digital content to an electronic presentation device includes transmitting the targeted digital content to a mobile communication device of at least one current rider of the vehicle.

12. The method of claim 9, wherein determining the targeted digital content includes
determining a first score for first potential digital content based on the average rider profile,
determining a second score for second potential digital content based on the average rider profile, and
selecting one of the first potential digital content and the second potential digital content as the targeted digital content by comparing the first score and the second score.

13. The method of claim 9, further comprising:
receiving feedback for the targeted digital content; and
updating at least one selected from a group consisting of the targeted digital content, the average rider profile, and the current rider profile based on the feedback.

14. The method of claim 9, wherein determining the average rider profile includes determining the average rider profile based on the current location of the vehicle and a time of day.

15. The method of claim 9, further comprising determining a route of the vehicle and wherein determining the average rider profile includes determining the average rider profile based on the at least one route.

16. The method of claim 15, wherein determining the route of the vehicle includes determining a direction of the vehicle.

17. The method of claim 9, further comprising determining a weather condition based on the current location of the vehicle and wherein determining the targeted digital content includes determining the targeted digital content based on the average rider profile and the weather condition.

18. The method of claim 9, wherein determining the targeted digital content includes determining the targeted digital content based on the average rider profile, the current location of the vehicle, the time of day, and an event.

19. Non-transitory computer-readable medium including instructions executable by an electronic processor to perform a set of functions, the set of functions comprising:
determining at least one current rider of a vehicle;
determining at least one current rider profile based on the at least one current rider of the vehicle;
determining a current location of the vehicle;
determining an average rider profile based on the current location of the vehicle;
determining targeted digital content based on the average rider profile and the at least one current rider profile; and
transmitting the targeted digital content to the mobile communication device.

20. The computer-readable medium of claim 19, wherein the set of functions further comprises receiving feedback from the mobile communication device for the targeted digital content and updating at least one selected from a group consisting of the targeted digital content, the average rider profile, and the at least one current rider profile based on the feedback, wherein the feedback indicates whether the current rider skipped at least a portion of the targeted digital content.
